(19) United States
(12) Patent Application Publication
(10) Pub. No.: US 2011/0184790 A1
(43) Pub. Date: Jul. 28, 2011

(54) Actionable Digital Cards, Related Content and Social Marketing

(76) Inventors: Kamaljit Deol Brar, Mississauga (CA); Shu Da, Thornhill (CA)

(21) Appl. No.: 12/573,153

(22) Filed: Oct. 5, 2009

(30) Foreign Application Priority Data
Oct. 18, 2008 (CA) 2,638,008

(51) Int. Cl. G06Q 30/00; G06F 17/00

(52) U.S. Cl. 705/14.4; 235/375

(57) ABSTRACT

The invention is a system and method for creating, managing and delivering actionable digital cards and related content to mobile devices. The system measures penetration of cards and provides measurable marketing, such as which consumer viewed which content. It allows an owner of a mobile device to acquire, manage, and act on actionable digital cards giving them the benefit of being able to acquire a large number of cards, their associated loyalty points, rewards, and any savings associated with related content. Further, it supports social marketing allow cards and related content to be recommended from person to person; benefiting all parties, whereby, individuals are made aware of cards and related content in a non-disruptive manner and enterprises are able to market their products and services through social marketing or “word-of-mouth” type advertising.

### CROSS-REFERENCE TO RELATED APPLICATIONS

This application claims priority to Canadian Patent Application No. 2,639,008 filed on Oct. 16, 2008 and which application is hereby incorporated herein by reference in their entirety.

### TECHNICAL FIELD OF INVENTION

This invention is related to wallets, digital wallets, marketing, social marketing, digital identification cards, and digital advertising.

### BACKGROUND OF THE INVENTION AND DESCRIPTION OF RELATED ARTS

Traditional physical wallets provide a place for people to store any physical cards, such as a business or library card, or paper based artifacts such as paper coupons. Due to the physical nature of the wallet and cards, people are constrained to the number of cards or informational artifacts they can hold. As a result, people are not able to maximize their benefits due to the limited number of cards or informational artifacts they may be carrying with them at time of purchase.

Electronic wallets and smart cards allow users to carry a larger set of identification numbers with them. However, they only retain the number but not other essential information such as a marketing brand, location based information, contact, or other descriptive information.

Cards are used to convey information about an individual or business. There are many types of cards, such as business, loyalty, member, personal cards, and well as for other uses. Business cards are usually carried by individuals and passed onto their business or personal acquaintances in order for a receiver of the card to be able to retain contact information. Loyalty and membership cards are show static content, usually, the brand of the loyalty program or issuer, a bar code, images and possibly some text.

Marketing involves making people aware of promotions, offers, and product information via paper based flyers, traditional mail, email, SMS, phone messages and solicitations. All these approaches for disseminating information clutter a person's mailbox, physical or electronic, thus placing a burden on an individual to sort through what is essential information versus what is spam or irrelevant information. Or they are disruptive, interrupting a person performing a task only to find non-timely or irrelevant information being presented to them.

Marketing information and sales can lead to informal sharing of information between individuals through referrals or recommendations via “word of mouth” advertising. Word of mouth advertising can encompass verbal means, as well as electronic such as text messages, online profile pages, bog posts, emails and instant messages. This type of advertising has significant value to marketers as it has been found that people are more inclined to believe word of mouth advertising over a company marketing directly to a person.

As it relates to cards and marketing, people view cards, advertisements, coupons, and relevant information and then opt to recommend/refer any of these to their friends, peers and anyone within their social network. Currently, people recommend cards, coupons, advertisement, promotions and other relevant information via verbal communication (word of mouth), email or some other communication medium. Should the individual receiving the information like what is being communicated to them; they will need to go through a separate process of applying for a card or getting their own copy of a coupon or advertisement. For example, after someone has been told by a friend of a great deal, that person may need to go home, turn on their computer, and navigate to a web site and fill an application form or fill out a paper form and submit it via traditional mail.

Measurable marketing: the ability to measure statistically the usage of marketing material by individuals and related increase of sales. For example, web tracking software tracks the number of times a web page or link has been displayed, or a web page is clicked. In the case of non-internet advertising, such as TV or print, marketing is measured by calling a subset of people receiving the material and asking sufficient questions in order to gain an understanding of its penetration and impact.

Application Process: Currently, users must fill in different forms having different form factors, such as paper forms, web based forms and at different locations. With these forms, the information requested and the order it is requested is generally different. As a result, the repetitive nature of applying for multiple cards and providing similar information in a non-consistent fashion makes the application process cumbersome to users. Therefore, many users opt to non-apply for cards, losing out on valuable rewards and/or benefits.

Disruptive Advertising: Advertisers today push adverts out to end users via email, mail, SMS, phone, and other communication channels. In a majority of the cases, marketing literature ends up mixed in with business or personal emails, mail, SMS messages, electronic messages or physical letters. This approach to marketing clutters a person's in-box with non-relevant or appropriately timed information, poses an inconvenience to people by requiring them to filter unnecessary information and interferes their task at hand. Further, receiving SMS or emails can result in unwanted monetary charges to a person receiving un-solicited messages.

By creating and combining new and unique approaches for a Digital Wallet, Actionable Digital Cards, Actionable Related Content, Card and Content Management software and related services provides, all the above listed issues and short falls with existing approaches are either eliminated or greatly improved upon.

A Digital Wallet provides the ability to store, manage and render a large number of related cards, contact information, adverts, coupons, and other related content on a device. It further has the capability to manage a larger number of Digital Cards or Related Content than the memory limitation of the device would allow. This allows a user to overcome physical device and run-time software limitations should they try to copy all items onto the device. The Digital Wallet further allows Digital Cards or Related Content to be available even when the mobile or storage device has no network connection. Benefits allowing an individual to be no longer constrained to the number of cards they have by the size of their physical wallet, provides a single consistent approach to applying for, organizing cards and related content.

Actionable Digital Cards and Actionable Related Content provide the ability to make use of any information contained within, such as, but not limited to, the ability to call telephone number, view maps or get directions, access additional data on the web, device or launch out an application, make recommendations thereby enabling Social Marketing. Paper, plastic, and Smart Cards contain information such as name, address, telephone number, company name, etc. But the form in which the information is rendered does not allow a user to be able to act on it without having to manually enter or search for this information on another application or manually enter this information into another device, such as phone or browser, or internet phone. For example, a user having a paper based business card needs to type the number into a phone and then can make a call vs. being able to make a call directly from the digital card itself. Another example is that an address may be listed on a card. There is no direct ability to view the location on a map or get directions to arrive at such a location without a user having to directly enter this information into a map application. Benefits include, enabling Social Marketing, ease of using information, receiving information in a non-disruptive manner, reducing cost of marketing, measurable marketing, lowering costs, and more timely marketing.

### BRIEF DESCRIPTION OF THE DRAWINGS

It is understood that the process flow and the following detailed description are exemplary and explanatory and not restrictive of the invention, as claimed. The process flow can be applied to any type of Digital Card or digital content as well.

FIG. 1. Represents a topology of a Digital Wallet, mobile device or storage device, and supporting Card and Content Management software application running on an application server.

FIG. 2. Represents a Card and Content Management server optionally integrated with 1 or more 3^{rd} party Card and Content Management servers, 1 or more Card Management servers, or accessed by 1 or more people responsible for Card and Content Management.

FIG. 3. Represents a Digital Wallet running on a mobile or storage device.

FIG. 4. Represents an example of a presentation of a Digital Card.

FIG. 5. Represents an example of a presentation of a Digital Card's Related Content.

FIG. 6. Represents a Digital Card being presented at a point of sale for redemption.

FIG. 7. Represents a Digital Card's Related Content being presented at a point of sale for redemption.

### DETAILED DESCRIPTION

It is to be understood that both the foregoing general description and the following detailed description are exemplary and explanatory and are not restrictive of the invention, as claimed.

The present system provides a method, systems, processes and software for creating and managing Actionable Digital Cards and Related Content, delivering and managing such information on a Digital Wallet application which runs on mobile and storage devices, implements and supports social and measurable marketing in a very cost effective, simple and efficient manner, and scalable from small to large corporations.

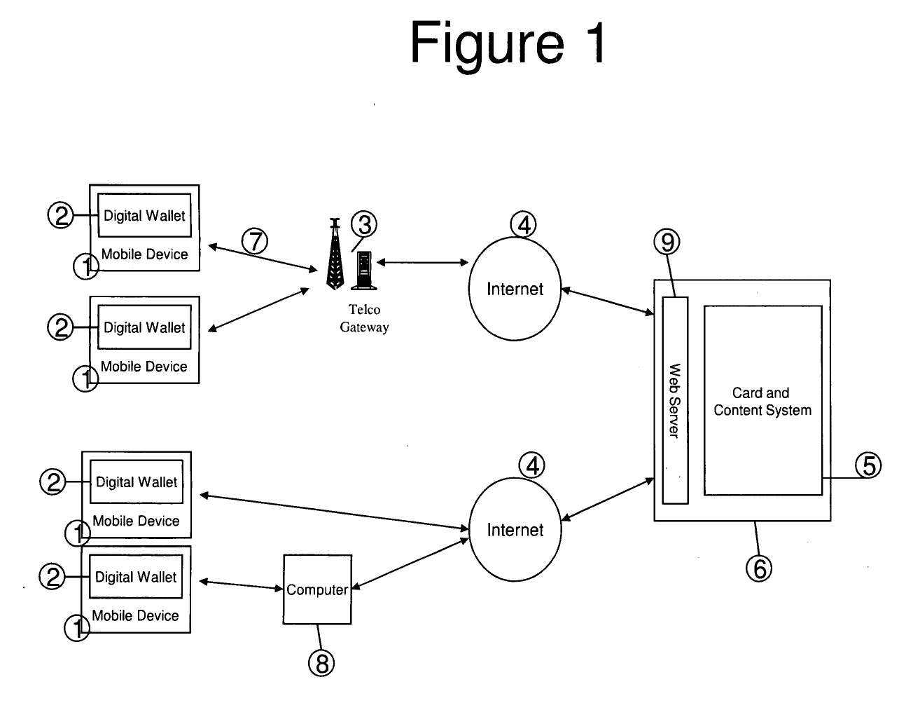

Referring to FIG. 1, the Digital Wallet (2) resides in a mobile device or storage device (1), such as a smart phone, PDA, cellular phone, or storage device. The Digital Wallet (1) communicates to the Card and Content Management software application (5) through a number of ways: (A) through a Telco's wireless network (7) having an internet gateway (3) which in turn communicates to Card and Content Management application (5) over the web (B) the device could have a connection with the internet (4) directly, for example, should the device have an 802.11 card, or (3) asynchronously by synchronizing with software on a computer (8), which in turn synchronizes with the Card and Content Management software application (5). The Digital Wallet (2) can also be realized through a web UI. In this case, the Digital Wallet (2) t and it's content is rendered in a mobile browser residing on the mobile device.

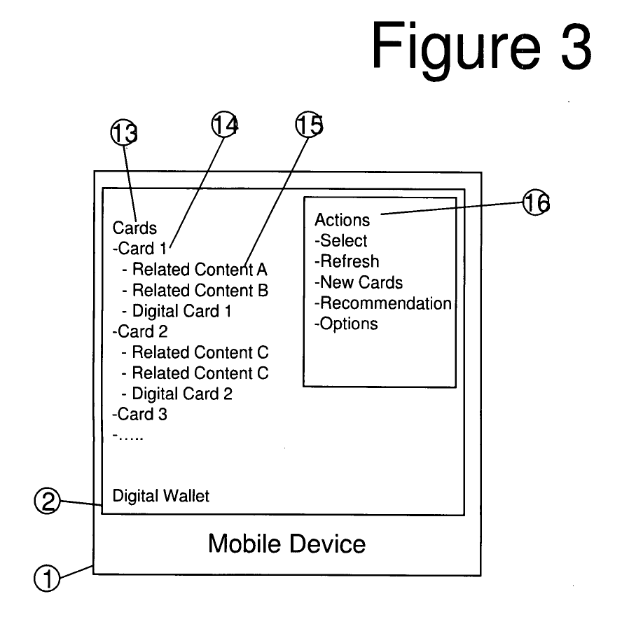

Referring to FIG. 3, the mobile device or storage device (1) can be of multiple forms, such as Smart Phones, cell phones, PDA's, or storage device which can store images or text. The Digital Wallet (2) holds digital cards (13) (Card 1, 2, and 3), and their related content (15). For example, “Card 1”, is related content is “Related Content A”, “Related Content B”, “Digital Card 1”. “Digital Card 1” is a visual representation of its details. This may include, but is not limited to, (15) one or more images, text, bar code images, bar code value, one or more web links, one or more telephone numbers, one or more email addresses. The Digital Wallet (2) has a set of context menu based actions (16) that can be executed. These include, but are not limited to, the ability to “Select” a card, related content or digital card details, refresh content on the device, view list of unsubscribed to “New Cards”, “Recommendation” of cards and related content from other users, and “Option” to configure the Digital Wallet (2).

When a person opens the Digital Wallet (2) on their device (1), they can view a list (13) of all cards they currently own. In order to view details, they traverse a list of cards and select one. For the selected card (14), a listing of available Related Content (15) (coupons, adverts, promotions, or supplemental information) and card details is presented. The user can select any one of the items listed, or opt to page to the next set of listings until they find one of interest. Once an item is selected, details are displayed to the user.

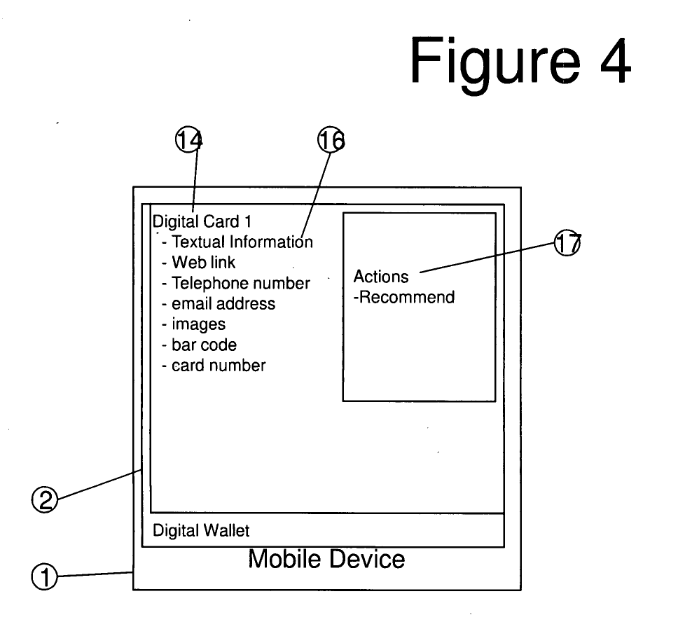

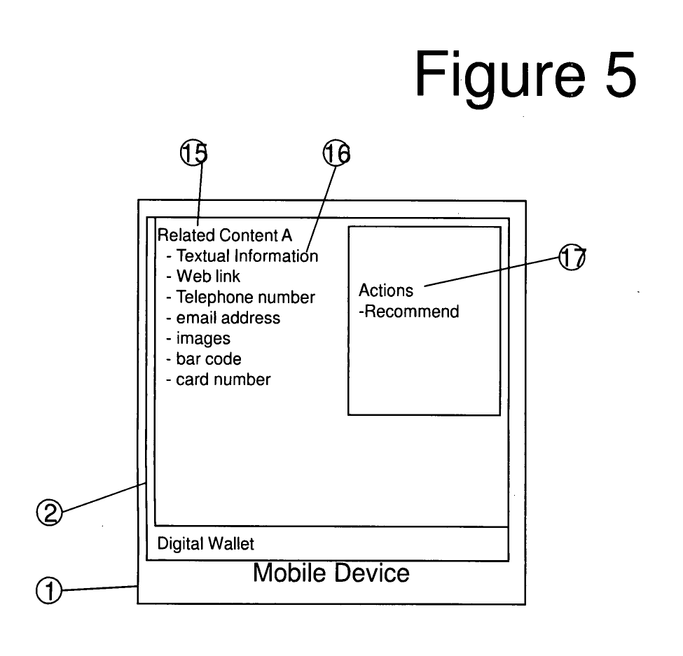

Referring to FIGS. 4 and 5, details of a Digital Card and Related Content (14) includes, but is not limited to, text, one or more web links, one or more telephone numbers, one or more email addresses, one or more images, optional bar codes and value of bar code represented in readable form, such as numeric or alpha-numeric form (16). Context menu's (17) make a Digital Card and Related Content actionable. The user can view and act on the information. For example, selecting the URL lets the user view additional information through a browser. Selecting a telephone number lets the user call out to that number, for example, to make a reservation. Actions made available, but not limited to, include the ability for a user to “Recommend” related content to another user.

Referring to FIG. 3, a user can view cards that he does not currently subscribe to. He does this by selecting “New Cards” (16). This results in a list of applicable cards being retrieved from the Card and Content Management application (5). The number of cards can far exceed the physical memory limits of a device, therefore, the listing supports pagination. The user traverses up, down, next and previous pages listing of cards until they find one of interest. The user can then view the details of the card and opt to apply for the card. If so, they can go through the application process which consists of selecting menu option “Apply” and confirming they are applying. Upon receiving a confirmation from the user, the Digital Wallet application (2) passes the user's credentials to the Card and Content Management application (5) for authentication. If the user is successfully authenticated, the application for a new card can be processed. This can either be done directly by the Card and Content Management System (5) or delegated to a 3^{rd} party software application (12) responsible for issuing cards. If the application is accepted, then a unique digital card is created and all relevant information is stored on the Card and Content Management application (5). A digital card is sent to the Digital Wallet (2) which stores and manages it on the device and renders it to the user.

The Digital Wallet (2) can hold a substantially larger set of Digital Cards (13) (and Related Content) then a device's (1) physical memory limitations would allow. When the number of cards held by a user is greater than the memory of the device (1), the Digital Wallet (2) selectively caches the cards on the device and the full set is stored on the Card and Content Management application (5).

Social Marketing: A network consists of a series of nodes, each representing a person or organization. The nodes are connected by means of a mutual relationship, whereby, each node knows each connected node through a direct relationship. Each node knows all other nodes through indirect relationships.

Users (10) have the ability to refer or recommend digital cards and related content to other users. These users can have a direct or indirect relationship with other users. By making recommendations to other people, each user becomes a node in a dynamically connected social network. The information being recommended to other users within this network is either Digital Cards or Related Content. This allows information to percolate through the network via electronic means similar to “word of mouth” marketing. As a result, companies can market their product, services, and other offerings indirectly through social marketing and reduce costs and increase effectiveness of their marketing.

Referring to FIGS. 4 and 5, a user can opt to recommend a Digital Card or related content to another Digital Wallet (1) holder. They do this, by selecting a Digital Card or Related Content and selecting the “Recommendation” option (16). They enter the contact information of the person they want to send it to, such as their mobile number. They can also optionally add textual information, such as the reason they are making the recommendation. The sender selects a menu option to “Send” this recommendation to the receiving party.

To get a listing of all Digital Cards or Related Content referred to a user, he selects option, “Recommendation” (16). Upon doing this, they will get a list of recommended Digital Cards or Related Content. The can select navigate and select from this list. When an item has been selected from the list, information identifying the sender and textual information entered by the sender is displayed. After viewing this content, a user can decide to apply for the recommended Digital Card or Related Content and receive any associated benefits and rewards.

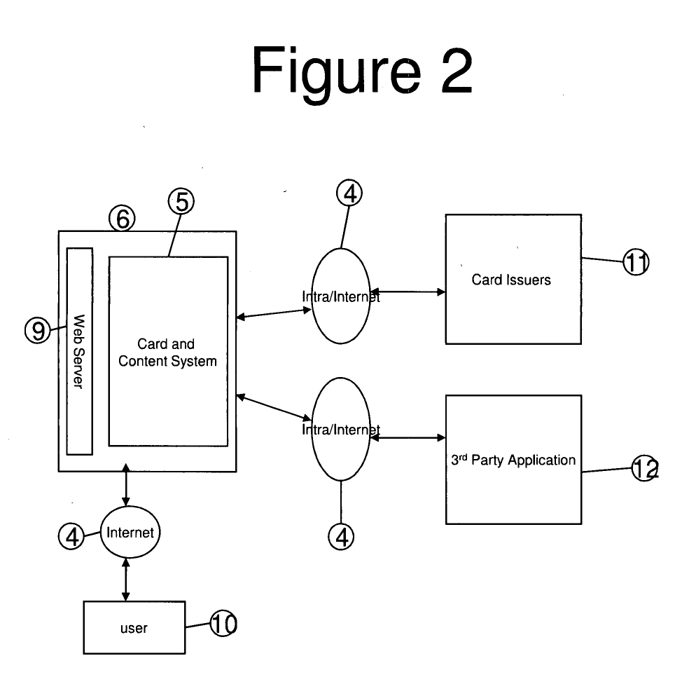

Referring to FIG. 2, card issuers (11) can create, manage and revoke digital cards by using the Card and Content Management application (5). The Card and Content Management application (5) is comprised of one or more software modules which provide security, authentication, authorization, and role based business rules for creating and managing Digital Cards and Related Content.

Card issuers must first create a Digital Card Type. A card type represents a generic version of the card and can optionally include text, web link, phone number, email address, images such as a thumbnail to be presented in a listing of digital cards within the Digital Wallet (2) and larger image to be presented when the card is viewed by a user, card category, and effective start and end dates. A card issuer optionally providing such information and can optionally filter to whom the card is available. Once this is done, the card is available, from the effective start date, for users to view and apply for. This information is stored in a software program, database and server machine.

Issuers of Digital Cards (11) can optionally create Related Content, such as digital marketing or informative information, such as reservation details. Similar to content of a Digital Card (14), a creator of Related Content (15) has the option of adding content, such as but not limited to, text, one or more web links, one or more telephone numbers, one or more email addresses, one or more images, optional bar codes and value of bar code represented in readable form, such as numeric or alpha-numeric form, category type, and effective start and end dates. This information is stored on the Card and Content Management application (5) comprised of application, database and one or more server machine. Starting from the effective start date the marketing or informative information is available to users on their device or hosted application for them to view and act on.

Referring to FIG. 2, Card issuers (11) or creators of Related content can either be a person or an automated service such as a 3^{rd} party application responsible for creating and generating cards and card numbers and Related Content such as marketing information. Card issuers (11) and 3 party applications (12) can connect to the Card and Content Management application (5) via the web or other communication platform.

Referring to FIGS. 4 and 5, Marketing and informative information is made available within the Digital Wallet (2), in the form of Digital Card and/or Related Content, either when a user refreshes the contents of the entire digital wallet, refreshes a particular Digital Card, or automatically as a user selects a digital card from a Digital Wallet's (2) card list. In all cases the Digital Wallet (2) requests the latest information from the Card and Content Management application (5) and then stores it locally on the device (1). By storing it locally, Digital Cards and their Related Content are made available even when the device does not have a network connection (offline) (7). Within a Digital Wallet (2) these cards are displayed in a list (or other form) to the user. The user can navigate and select from the list. When a card is selected, the marketing or informative information created for that user is displayed. These cards are also actionable and the user has the option of being able to execute any action made available on a card. The fetching of information can be done synchronously in real-time or asynchronously at a later time.

Related Content, such as marketing or informative information is made available with the Digital Wallet (2). It is not sent to a device via email, SMS, automated phone call, or other means which inconvenience a user.

Measurable Marketing: The Digital Wallet (2) has the ability to measure a number of attributes when a user views a card or related content. For example, but not limited to:
Which items (Digital Cards, Related Content) (14, 15) have been loaded onto a device
Which Digital Cards have been applied for, subscribed to, cancelled
Which and number of times a specific Digital Card or Related Content is viewed
Aggregation of information related to the above.

Further, the Card and Content Management application (5) can measure Digital Cards or Related Content has been downloaded to a device, viewed by a user, and acted upon. Such as if a digital coupon has been redeemed, card has been presented at a point of sales and so on. Combined with a Card and Content Management application the overall system has the ability to aggregate such information across users, user information (such as age, sex, location, and other demographic information) and measure the effectiveness of a marketing campaign or other marketing initiatives.

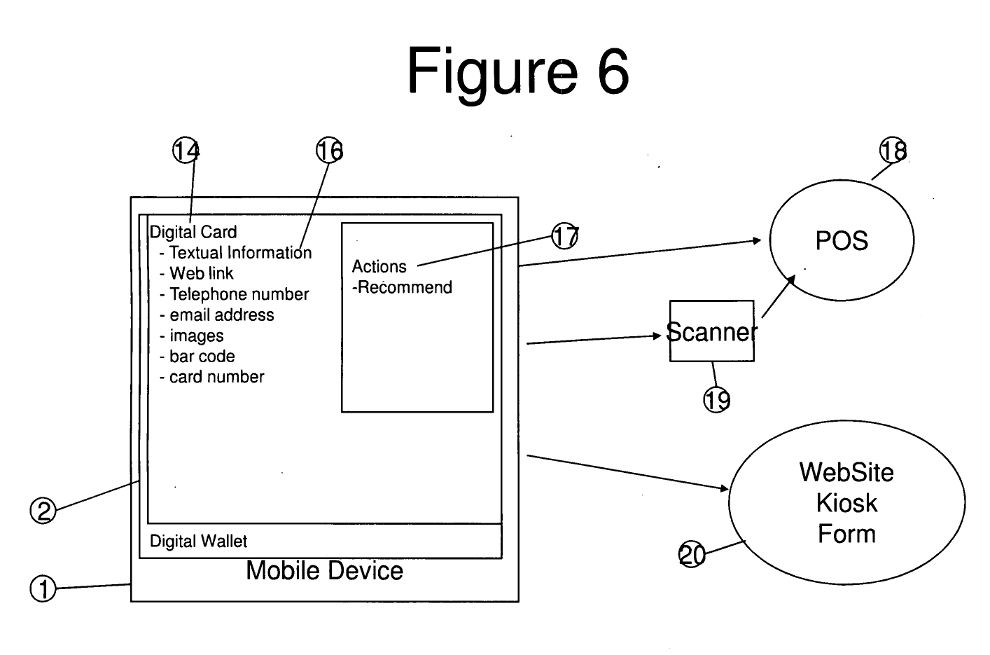

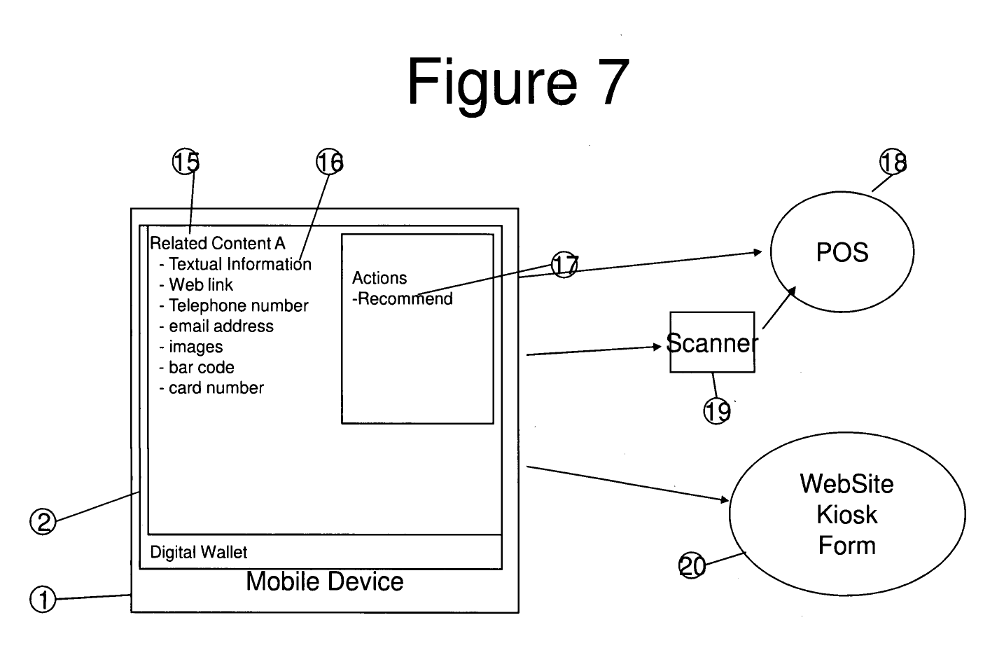

Referring to FIGS. 6 and 7, a Digital Card or Related Content (14, 15) can be presented at a point of sale or redemption (18), a sales representative may view or enter the information into a software application, or transcribe to paper, or any other form to track that the card has been presented. Both a Digital Card and Related Content's bar code (16) can be scanned by a digital scanner (19), such as Metrologic 6110. The transfer of a Digital Card or Related Content's content is not limited to the representation of information. For example, the bar code or number can also be transferred between the device and terminal using Bluetooth and infrared technology. A Digital Card does not need to be scanned in by a sales person, it may be self scanned by a user in a self-service check-out having a digital scanner, kiosk (20), transcribed by a user into a website form, paper, or any other medium in which a Digital Card's information/number can be entered or filled in.

I claim:

1. A computer system for storing, creating, managing, delivering, presenting, information in the form of digital cards and related content; enabling both digital cards and related content to be actionable; supporting social and measurable marketing; and communicating such information between parties in a non-disruptive manner; comprising: a storage device having an optional client software application in communication with a communication network; wherein said client software application is in communication with a central software application hosted on a computing server through the internet; wherein said central software application is in communication with a database and 3^{rd} party software applications through the internet

2. The computer system of claim 1, wherein the storage device is a mobile device or any storage device which at a minimum can store alpha-numeric values and picture images.

3. The computer system of claim 1, wherein the client software application has algorithms for, but is not limited to, receive, synchronize, store, manage storage of, present digital content; execute actions on digital content presented; store, manage and present authentication information of a user, functionality to recommend cards to one or more users of the system; measure digital content stored, viewed and acted on; the client software application can either reside on the storage device or can be a web based and rendered within a Web browser.

4. The computer system of claim 3, wherein the digital content is comprised of at a minimum of digital cards and related content; wherein, digital cards and related content is comprised of one or more or any combination of: text, textual data, image, web links, telephone numbers, email addresses, bar codes, numeric and alpha-numeric information.

5. The computer system of claim 1, wherein the communication network between the client storage application and central software application can be comprised of a combination of cellular network, interne, wireless, and synchronization software.

6. The computer system of claim 1, wherein the central software application has algorithms for, but not limited to: define, create, manage, update, remove, store, and filter digital content; manage associations and state of associations between digital content and users; supporting the concept of social marketing; manage associations of digital content recommended between users; deliver content to the client software application as requested; enumerate and aggregate information collected by client software application; exchange information between 3^{rd} party software applications

7. A method for storing, creating, managing, delivering, presenting, information in the form of digital cards and related content; enabling both digital cards and related content to be actionable; supporting social and measurable marketing; and communicating such information between parties in a non-disruptive manner;

8. The method of claim 7, further comprising of a client software application storing the user's identification information or a web base client software application being available on a storage device.

9. The method of claim 8, further comprising the step client software application authenticates the user with the central software application using the user's identification over a network communication and receiving all subscribed to and applicable digital cards and related content and presenting a list of said digital cards and related content to a user.

10. The method of claim 9, of user selecting, viewing and presenting a digital card or related content details or executing any action available on the digital card or related content.

11. The method of claim 9 wherein the digital card and related content is a single or optionally includes a combination of text, one or more web links, one or more telephone numbers, one or more email addresses, one or more images, optional bar codes and value of bar code represented in readable form, such as numeric or alpha-numeric.

12. The method of claim 9 wherein the action available can include, but is not limited to, being able to recommend said digital card to another user, being able to call a number, browse a web link, send email, SMS, display content, maps.

13. The method of claim 8, further comprising of the step a user selecting to view a listing of unsubscribed cards, recommended cards, and recommended related content.

14. The method of claim 13, further comprising of the step of client software application receiving all applicable digital cards and related content and presenting a list of said digital cards and related content to user; user selecting and apply for said digital card or related content;

15. The method of claim 14, further comprising of the step of central software application approving the request from user; generating a unique digital card for user including unique number and digital content; and storing said digital content

16. The method of claim 15, further comprising of the step of client software application receiving a digital cards having a unique number and it's related content upon a successful application response; and optionally storing said digital cards and related content on storage device

17. The method of claim 10 further comprising the step of a user presenting a digital card or related content at a point of sale wherein the bar code or presented number is scanned in.

18. A method of claim 10 further comprising of the step of associating which and the number of times a digital card and related content have been viewed or acted upon by a user; storing this information in the client software application and communicating it to the central software application.

19. The method of claim 15 further comprising of the step of the central software application keeping association between user and digital card and related content and aggregating such associations across all users

20. The method of claim 10 wherein the presented bar code or digital content is scanned in using a digital scanner or transcribed manually or transferred from storage device to receiving terminal over a communication network comprising of a wireless network, Bluetooth, infrared, or other wireless transports.

21. A method for a user or 3^{rd} party system to create, manage, update, store, remove, and filter digital content that users of client software application can subscribe to comprising of a central software application.

22. A method of claim 20 wherein the digital content is digital cards and content related to digital cards

23. A method of claim 9 wherein the communication is one or combination of cellular network, interne, wireless, synchronization software.

24. A method of claim 15 wherein the central software application is web based and communication network to access it is the Internet.
